(19) United States
(12) Patent Application Publication
(10) Pub. No.: US 2005/0274241 A1
(43) Pub. Date: Dec. 15, 2005

(54) Method of making a contact lens with prism

(76) Inventors: Robert B. Mandell, Moraga, CA (US); Charles E. Campbell, Berkeley, CA (US)

Correspondence Address: ROBERT B. MAMDELL, 69 SULLIVAN DR., MORAGA, CA, 94556, US

(21) Appl. No.: 10/866,590

(22) Filed: Jun. 12, 2004

(51) Int. Cl. B23B 3/00

(52) U.S. Cl. 82/1.11

(57) ABSTRACT

A manufacturing method for a contact lens with secondary prism in which a button of contact lens material, having a posterior surface of suitable design for fitting the needs of the eye, is mounted on a lathe and the front surface of the lens formed by the steps of: 1. Cutting a front surface, forming a single vision or bifocal lens with an initial prism. 2. Cutting away a portion of the initial prism so as to form a secondary prism. This method requires fewer steps and is faster than methods used previously.

### FEDERAL SUPPORT

This invention was made with government support under grant 1-R43 EY14286-02, awarded by the National Institutes of Health. The government has certain rights in the invention.

### CROSS REFERENCES TO RELATED APPLICATION

None

### FIELD OF THE INVENTION

This invention relates to a method of making a contact lens with a secondary prism.

### PRIOR ART

Contact lenses may be classified in various ways. If classified by number of optical powers they are usually divided into single vision and bifocal lenses. Single vision lenses may be comprised of spherical, aspherical and toric surfaces. Bifocal contact lenses are lenses with at least two regions of different optical powers, known as zones or segments. Usually, one power is chosen to provide the wearer with clear distance vision and the second power to provide clear near vision, but any two powers may be selected. Bifocal contact lenses also may be called multifocal contact lenses, although the latter term is sometimes reserved for lenses comprised of at least three regions with different optical powers or regions of variable power, as in U.S. Pat. No. 5,517,260 (Glady) and U.S. Pat. No. 5,754,270 (Rehse).

Bifocal contact lenses generally are classified into two types, concentric and vertically segmented. Both types can be produced as rigid or soft contact lenses. Concentric bifocal contact lenses have a central power zone surrounded by one or more annular zones of different powers or a sequence of alternating powers. Generally, the lens is designed so as to have little motion on the eye and the wearer views through portions of more than one zone at the same time, a process called simultaneous vision, as described in U.S. Pat. No. 4,636,049 (Blacker); U.S. Pat. No. 4,752,123 (Blacker); U.S. Pat. No. 4,869,587 (Breger); and U.S. Pat. No. 5,864,379 (Dunn). The distance and near zones, together with optional transition curves, comprise the bifocal area. The peripheral portion of the lens is comprised of one or more curves that are used to connect the bifocal area to the edge perimeter, including options currently in use such as prism ballast, slab-off, tapers, peripheral curves, lenticular curves, and truncations.

Vertically segmented bifocal contact lenses have vertically separated power zones, an upper zone that usually provides the appropriate correction for viewing far distances and a lower zone, which usually provides the appropriate correction for viewing near distances. The lenses are designed to alternate their position in front of the pupil when the lens moves up and down on the eye as the result of lid forces, which occur when the wearer changes gaze between different distances, a process called alternating vision, as described in U.S. Pat. No. 3,597,055 (Neefe) and U.S. Pat. No. 3,684,357 (Tsuetaki). If there is little vertical movement then vertically segmented bifocal contact lenses may also function as a simultaneous vision lens. The two vertically separated power zones maintain their relative positions by various features that can be added to control the lens position and stabilize the meridional rotation as described in U.S. Pat. No. 4,095,878 (Fanti); U.S. Pat. No. 4,268,133 (Fischer); U.S. Pat. No. 5,760,870 (Payor); U.S. Pat. No. 5,296,880 (Webb); and U.S. Pat. No. 4,573,775 (Bayshore). This is commonly accomplished in rigid bifocal contact lenses by incorporating a prism into the lens, which provides a progressively greater thickness from the top to the bottom of the lens. The prism serves to maintain the desired lens orientation and keep the lower zone of the lens downward on the eye as described in U.S. Pat. No. 5,430,504 (Muckenhirn) and U.S. Pat. No. 4,854,089 (Morales) and in Burris, 1993; Bierly, 1995, and Conklin Jr. et al, 1992. The lower edge of the lens is designed to rest upon the lower lid margin of the wearer and the lens shifts up and down relative to the eye as the result of lid forces. There are several subtypes of vertically segmented bifocal contact lenses, based on the shape of the near zone, including round, D-shaped, flat, crescent, and others as described by Conklin Jr. et al, 1992 and in U.S. Pat. No. 4,618,229 (Jacobstein) and U.S. Pat. No. 5,074,082 (Cappelli).

There have been attempts to incorporate prism into soft bifocal contact lenses for the same functional purpose as prism provides for rigid lenses. U.S. Pat. No. 4,549,794 (Loshaek); U.S. Pat. No. 5,635,998 (Baugh); U.S. Pat. No. 4,618,229 (Jacobstein) Ezekiel, 2002, but generally these lenses have inadequate lens movement or produce discomfort to the wearer. There also have been attempts to induce a vertical shift of a soft bifocal contact lens by adding features to the lower periphery of the lens, as described in U.S. Pat. No. 4,614,413 (Obssuth); U.S. Pat. No. 5,635,998 (Baugh); U.S. Pat. No. 6,109,749 (Bernstein): U.S. Pat. No. 5,912,719; and European Pat. EP0042023 (Muller).

U.S. Pat. No. 6,746,118 to Mandell describes a contact lens comprising a secondary prism that controls vertical lens movement on the eye of a wearer. The anterior surface of the lens has a central optical portion, which in one embodiment contains a bifocal design comprising a distance zone located above a near zone. The secondary prism has a base that extends forward from the lower region of the anterior surface of the lens. When the lens is worn, the base is in apposition or near apposition to the lower lid so that as the wearer looks downward the lid holds the lens in place, which produces an upward movement of the lens relative to the eye. This allows the wearer to view through the lower part of the central optical portion, which contains the optical power for near vision.

U.S. Pat. No. 6,746,118 to Mandell also describes a method for manufacturing a contact lens with secondary prism, which involves a process whereby a lens button, consisting of a cylinder of contact lens material, is machined in a series of steps using an optical lathe. In machining the front surface the first step is to form the button into a shape resembling the top of a hat. Next, the peripheral portion of the hat is shaped to form in part a primary prism and then the central portion of the hat is shaped to form in part a secondary prism and the power zone(s). Various other lens features are added for design enhancements.

### SUMMARY OF THE INVENTION

In brief terms, the manufacturing method of the present contact lens starts with a button of contact lens material having a posterior surface of suitable design for fitting the needs of the eye, and forms the front surface of the lens by:
1. Cutting a front surface to form a single vision or bifocal lens with an initial prism.
2. Cutting away a portion of the initial prism so as to form a secondary prism and an optional lenticular.
   For single vision contact lenses, including toric lenses, as well as certain types of bifocal lenses, it is possible to make some lens designs of the present contact lens by using a manual lathe. More complex designs may be manufactured with the use of modern computer-controlled lathes with oscillating tool technology, such as the DAC ALM lathe or the Sterling Optiform lathe.

### OBJECTS AND ADVANTAGES

We have developed an improved method for manufacturing a contact lens with secondary prism that conforms to the design principles described in U.S. Pat. No. 6,746,118 to Mandell but which avoids the need for the step of forming a hat shape to the button. The elimination of this step speeds the manufacturing process and decreases the cost of production.

The present contact lens has the advantage that, regardless of whether a manual lathe or a computer-controlled lathe is used, fewer steps are required for lens production. A manual lathe may be used when lower cost of production is desired or a computer-controlled lathe is not available. A computer-controlled lathe may be used when production speed and versatility are desired, or for complex bifocal lenses and other advanced lens designs.

It is an object of this invention to provide a method of manufacturing a contact lens with secondary prism that eliminates the step of constructing a hat shape to a button of contact lens material before lathe cutting the parts of the front surface of the contact lens.

It is a further object of this invention to reduce the time and cost that is required in using either a manual or computer-controlled lathe for manufacturing a contact lens with secondary prism.

### BRIEF DESCRIPTION OF DRAWINGS

FIG. 1 is front plan view of one embodiment of the present contact lens.

FIG. 2 illustrates a cylindrical button of contact lens material shown in a midline cross-section.

FIG. 3 illustrates a midline cross-section of the button of FIG. 2 mounted on an arbor which may be offset.

FIG. 4 illustrates the method used to calculate a prism angle.

FIG. 5 illustrates a lathe equipped with a cutting tool having a center of rotation.

FIG. 6 illustrates a secondary prism lathed indirectly by cutting away a section using the lenticular radius.

FIG. 7 illustrates a series of lathe cuts of the lenticular radius from the button side inward to the base.

FIG. 8 illustrates a locus of points generated by the tip of the tool radius.

FIG. 9 illustrates the highest point of the lenticular section.

FIG. 10 illustrates the calculation of the highest points of the lenticular.

FIG. 11 illustrates the shape of the cutting tool end.

FIG. 12 illustrates the dimensions of the secondary prism base

FIG. 13 illustrates the relationship between the cutting tool shape and the lower lens shape.

FIG. 14 illustrates the various shapes of the lenticular.

FIG. 15 illustrates the relationship between the cutting tool movement and the lower lens shape.

FIG. 16 illustrates the various surfaces possible for the secondary prism and lenticular.

FIG. 17 illustrates the rounding of corners for the secondary prism base and lenticular.

FIG. 18 illustrates a second lenticular.

FIG. 19 illustrates a decentered lenticular and a bifocal construction.

FIG. 20 illustrates the various possible positions for a secondary prism base when there is a second lenticular

FIG. 21 illustrates a prism base that is essentially straight.

### DESCRIPTION OF INVENTION

In each embodiment of the current invention that follows, the posterior surface of the lens is formed first by lathe cutting or molding using standard methods available in the contact lens industry (DAC. Manual of 3x lathe Operation). The posterior surface may be spherical, aspherical, toric, with or without peripheral curves, and may contain one or more powers in the form of a bifocal or multifocal.

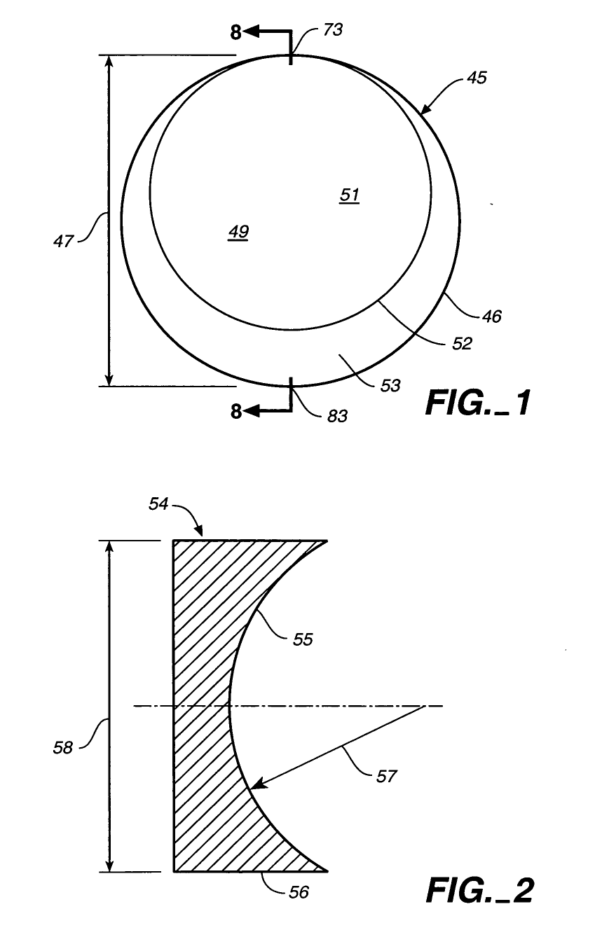

FIG. 1 illustrates a front plan view of one embodiment of the present contact lens, comprising a single vision contact lens 45 with an edge perimeter 46, a diameter 47, a spherical front surface 49, an optical portion 51, a secondary prism 52, and a lenticular 53. Lens 45 is constructed from a cylindrical button 54 of contact lens material shown in a midline cross-section in FIG. 2 as having a preformed back surface 55, extending to a button side 56, and comprising a single spherical radius 57. Button 54 has a diameter 58 that is equal to lens diameter 47, or button 54 is trimmed to equal diameter 47.

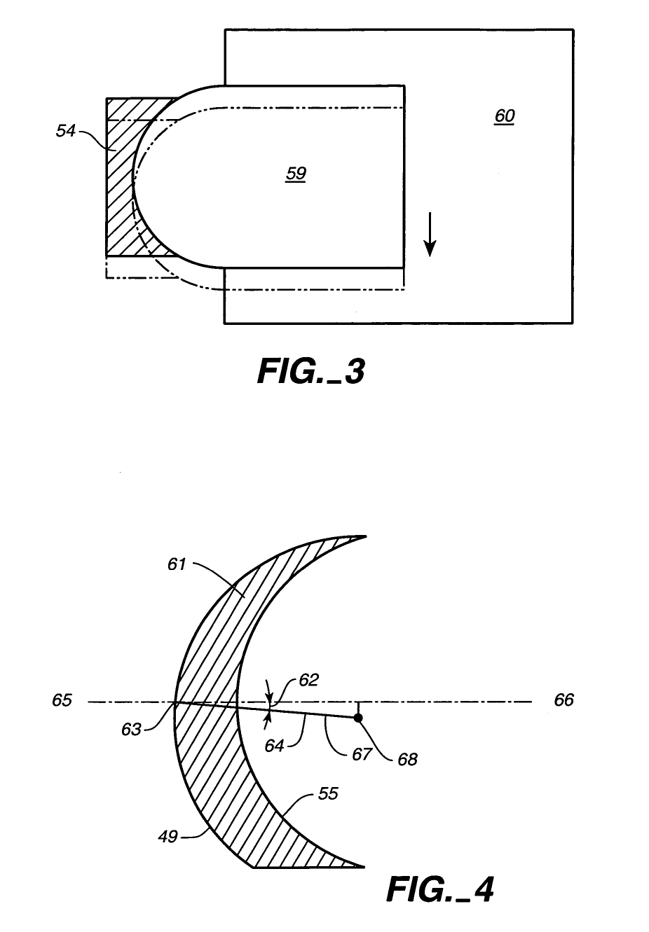

FIG. 3 illustrates a midline section of button 54 mounted on an arbor 59 with lateral offset capability, which is held in a lathe 60 for cutting front surface 49. In FIG. 4 an initial prism 61 of a power, d, is selected as an independent parameter by the lens designer and used to calculate a prism angle 62, at a position 63 where a normal 64 to front surface 49 forms an intersection with a central axis 65 of spherical back surface 55. At this stage in the manufacturing process, central axis 65 coincides with a turning axis 66 of lathe 60.

Prism angle 62 is determined by the formula:
a=d/(n−1) Formula 1.1
where:
a=prism angle 62
d=deviation power of the prism expressed in prism diopters
n=index of refraction of the lens material

Formula 1.1, strickly speaking, applies only to optically thin prisms, which is not usually the case for contact lenses, but is adequate to illustrate the principles presented here. In addition, for this application, formula 1.1 applies only to position 63. Prism power above or below position 63 will vary according to the slope difference between front surface 49 and back surface 55. Prism angle 62 and a radius 67 of front surface 49 are sufficient information to find the coordinates for a center of curvature 68 for front surface 49. Using position 63 as the origin it is found that:
x=radius 67(cosin A)
and
y=−radius 67(sin A)

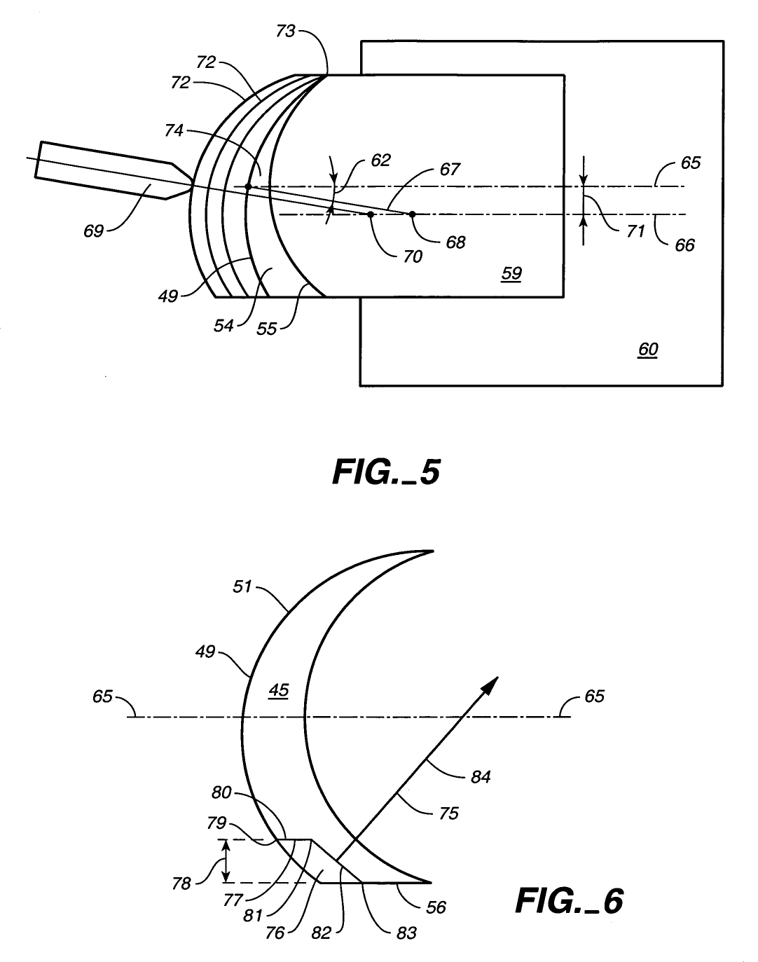

Lathe 60 is equipped with a cutting tool 69 having a center of rotation 70 as shown in FIG. 5. The desired front surface 49 with initial prism angle 62 can be lathed if center of rotation 70 of cutting tool 69 coincides at its final cutting position with center of curvature 68. This is accomplished by first using offset arbor 59 to decenter button 54 by an amount equal to a distance 71 of center of curvature 68 of front surface 49 from axis 65 of back surface 55. Axis 66 of lathe 60 also will be distance 71 from axis 65. Next, a lathe cut 72 is made using radius 67 and repeated while advancing cutting tool 69 in steps along lathe axis 66 until sufficient material is removed to produce front curve 49 for lens 45, having a top edge 73 of specific thickness and a center thickness 74. Cutting tool 69 is then retracted and a change made to a radius 75 for cutting a lenticular 53.

Secondary prism 52 is lathed indirectly, by cutting away a section 76 from button 54 using lenticular radius 75, as shown in FIG. 6. The choice of radius 75 is based on the parameters of secondary prism base 77 and other lens parameters, which are independent and chosen by the lens designer. Secondary prism base 77 is first assigned a height 78, from button side 56 to a front point 79 on the lower region of front surface 49. Next, base 77 is assigned a depth 80, which extends from point 79 along a parallel with axis 65 to a control point 81 within lens 45. Next, a line segment 82 is constructed from control point 81 to a lower edge 83 of lens 45. The perpendicular bisector of line segment 82 forms a radius line 84 from which lenticular radius 75 is assigned as an independent parameter.

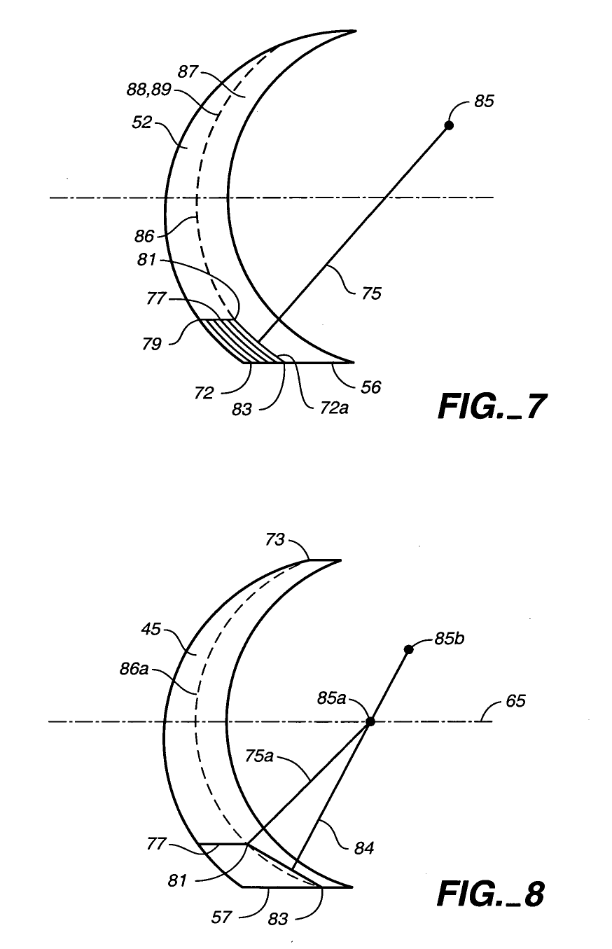

Secondary prism 52 is formed by making a series of lathe cuts 72 of lenticular radius 75, from button side 56 inward to base 77, which proceed in steps from base front point 79 to control point 81, as shown in FIG. 7. After each lathe cut 72, cutting tool 69 is retracted along base 77 to front point 79 and then moved to the next cutting position on button side 56. At a final lathe cut 72a, cutting tool 69 moves around a center of curvature 85, along a locus of points 86 that passes through lower edge 83 and control point 81, dividing initial prism 61 into secondary prism 52 and a primary prism 87. Locus of points 86 represents a common curve for back surface 88 of secondary prism 52 and a front surface 89 of primary prism 87.

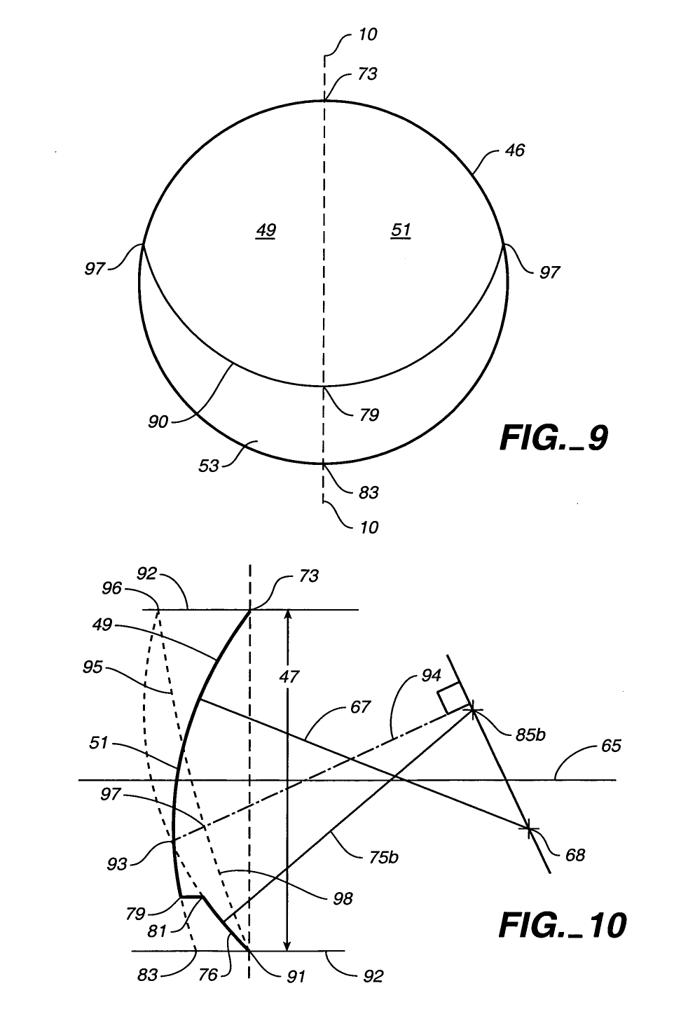

There is a single lenticular radius, 75a which has the unique property of producing a lens with equal edge thickness for the entire length of an edge perimeter 91. Radius 75a has a center of curvature 85a, which occurs where radius line 84 intersects back surface axis 65. Radius 75a has a length equal to the distance from center of curvature 85a to control point 81. A locus of points 86a, generated by the tip of radius 75a will pass through both a top edge 73 and lower edge 83 of lens 45, as well as control point 81, as shown in FIG. 8. Base 77 of secondary prism 52 begins a ledge 90 (FIG. 9) which has a maximum depth at base 77 and extends laterally and upwardly with decreasing depth. The front orthogonal view in FIG. 1 shows that lenticular 53 appears to be wide at lower edge 83 and narrows gradually to zero at top edge 73.

In another embodiment of the present contact lens, a lenticular radius 75b is made longer then unique radius 75a so that a center of curvature 85b falls away from axis 65. A highest point 97 of lenticular section 76 on each side of lens 45 will occur below top edge 73, as shown in FIG. 9. Highest points 91 97 of lenticular section 76 may be calculated as follows:

In FIG. 10, lens front surface 49 is shown in cross section before lenticulation extending from a top edge point 73 to a bottom edge point 83 on a front surface perimeter 91, which is limited by the surface of a construction cylinder 92, with axis of symmetry coincident with axis of back surface 65 and a diameter equal to lens diameter 47. Front surface 49 is a sphere with center of curvature 68 and radius 67. Lenticular 76 is a sphere of radius 75b and center of curvature 85b.

As is known from the principles of geometry, the locus of points representing the intersection of two spheres with centers of curvature that are not coincident is a circle. When the circle is projected onto a plane containing both centers of curvature it is seen as a straight line that passes through a point where the spheres are seen to intersect and is perpendicular to a line connecting the two centers of curvature. In FIG. 10 front surface 49 and the projection of lenticular sphere section 76 intersect at a point 93 in the plane that also contains centers of curvature 68 and 85b. A locus of other points of intersection, projected normal to the plane containing centers of curvature 68 and 85b, is a line 94 passing through point 93 and perpendicular to a line passing through centers of curvature 68 and 85b.

From the principles of analytic geometry, the locus of points representing the intersection of a cylinder and sphere is an ellipse when viewed in front and a parabola when viewed from the side. In FIG. 10 the locus of points formed by construction cylinder surface 92 and sphere 76 is an ellipse when viewed from the front and a parabolic arc 95 when viewed from the side. Parabolic arc 95 extends from lower edge 83 to a point 96 on the top side of construction cylinder 92.

Point 97 is common to the intersection of the straight line 94, lenticular 76, and parabolic arc 95. The locus of points where lenticular 76 intersects lens perimeter 46 is represented by a curved line 98, the portion of parabolic arc 95 connecting point 97 and lower edge perimeter 91. Point 97 is the point on each side of the lenticular perimeter that is highest for lens 49.

To find the vertical distance between point 97 and the lower edge of construction cylinder 92 the following equations for parabola 95 and line 94 are first given. Designating the radius of curvature of the front surface 67 by the symbol rf, the radius of curvature of lenticular 75b by the symbol rs, the vertical distance from center of curvature 68 to line 65 by the symbol yf, the horizontal distance from the line connecting point 83 and point 73 to center of curvature 68 by the symbol xf, the vertical distance from 85b to line 65 by the symbol ys and the horizontal distance from the line connecting 83 and 73 to center of curvature 85b by the symbol xs, the equation for line 94 is;

$$x = \frac{( {rs}^{2} + {xf}^{2} + {yf}^{2} ) - ( {rf}^{2} + {xs}^{2} + {ys}^{2} )}{2 ( xf - xs )} - \frac{( yf - ys )}{( xf - xs )} y$$

By designating the groups of constants

$$a = \frac{( {rs}^{2} + {xf}^{2} + {yf}^{2} ) - ( {rf}^{2} + {xs}^{2} + {ys}^{2} )}{2 ( xf - xs )} and b = - \frac{( yf - ys )}{( xf - xs )}$$

The equation for line 94 simplifies to
x=a+by (1)

Using the same symbols for the radius of curvature of the lenticular 75b and the coordinates of its center of curvature 85b and designating the diameter of the of the lens 47 by the symbol Φ, the equation for parabola 95 representing the intersection of lenticular 76 and the edge of lens 49 is
x²−(2xs)x−(2ys)y+(xs²+ys²−rs²+Φ²/4)=0

Designating the constant groups as
c=−2xs; d=−2ys; e=(xs²+ys²−rs²+Φ²/4)

The equation for parabola 95 simplifies to
x²+cx+dy+e=0 (2)

When the expression for x given in equation (1) is substituted for x in equation (2) a solution for the y value of intersection point 97 is found to be

$$y = \frac{- ( 2 ab + bc + d ) - \sqrt{{( 2 ab + bc + d )}^{2} - 4 {b}^{2} ( {a}^{2} + ac + e )}}{2 {b}^{2}}$$

The vertical distance from the lower edge of construction cylinder 92 to 97 is then
Φ/2+y

A secondary prism power, P2, may be found from the difference in slopes of front surface 49 at axis 65 and back surface 88 of secondary prism 52 at axis 65. The difference in slopes equals a secondary prism angle and the power of secondary prism P2 may be found from Formula 1.1.

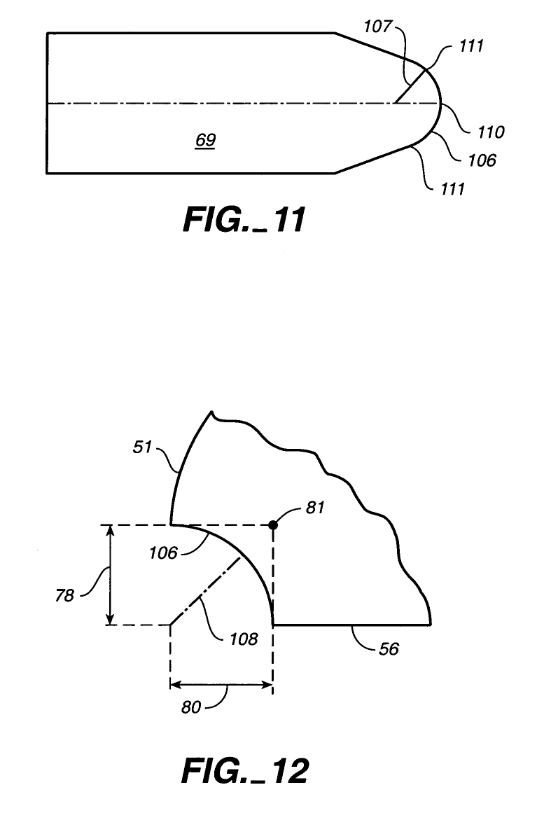

Although, it is convenient and common for illustration purposes to show a cutting end 106 of cutting tool 69 as a point, it is recognized by those skilled in the art that cutting end 106 in application must have a finite radius 107. The shape and radius 107 of cutting end 106 will have an influence on the shape and radius 108 of secondary prism base 77, along with the manner in which it is cut. Cutting end 106 may be round as in FIG. 11, or one of various aspheric curves having radius 107 at its cutting tip 110, located at its most forward point. Radius 107 of commonly available lathe cutting tools may vary from about 0.1 mm to about 1.0 mm. Cutting tool 69 is constructed to produce cutting action at a cutting tip 10 or at any cutting point 111 representing one of a group of cutting points up to about 80 degrees away from either side of cutting tip 110.

If height 78 and depth 80 of secondary prism base 77 are each equal to radius 107 of cutting end 106, and cutting end 106 is spherical, the same spherical shape with radius 107 will be cut as a secondary prism base radius 108, shown in cross section as FIG. 12. A simple inward motion of cutting end 106 from button side 56 will produce such a curve for base 77. From the geometry, it follows that for this example, base radius 108 cannot be smaller than radius 107 of cutting end 106.

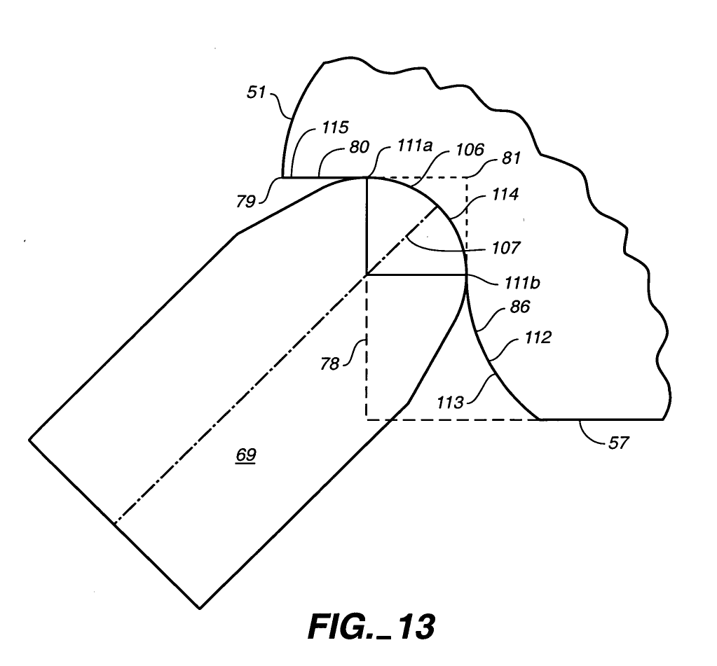

If depth 80 of secondary prism base 77 is larger than radius 107 of cutting end 106, it is necessary to impart forward motion to cutting tool 69 in addition to the inward motion during the cutting process for lenticular 76, as shown in FIG. 13. In addition, if height 78 of secondary prism base 77 is larger than radius 107, it is necessary to impart x,y motion inward that is greater than radius 107. During a final lathe cut 72a, cutting end 106 follows the locus of points 86 but must stop before reaching base control point 81, or a cutting point 111a on the side of cutting tool 69 will remove a portion of secondary prism base line 80. The final inward motion of cutting tool 69 must end when cutting point 111a is tangent to base line 80 of secondary prism 52 and a cutting point 111b is tangent to locus of points 86. From the final inward position, cutting tool 69 is moved forward along base line 80 until cutting point 111a has reached base front point 79. The resulting shape 112 comprises a beginning segment 113 for the lenticular portion formed by x,y movement of cutting tool 69 inward, a central segment 114 formed by the shape of cutting tool end 106, and a final segment 115, formed by the movement of cutting tool 69 forward. The secondary prism base is now comprised of central segment 114 and final segment 115. The junction between each segment is smooth, as no change occurs in the first derivative of the contiguous curves. The base forms a ledge which begins transversely and continues to either side of the base with either constant, increasing or decreasing depth.

If, for a given set of lens parameters, cutting end 106 of cutting tool 69 has a very small cutting end radius 107, or the height of lenticular segment 113 is large, there must be a significant movement of cutting tool 69 towards control point 81 before it changes direction towards front point 79. Conversely, if cutting end 106 has a large end radius 107, it will require less inward movement. The cutting end radius 107 may be smaller than radius of central segment 114 but cannot be larger. The length of the final segment 115 will depend upon the arithmetic difference between base depth 80 and cutting end radius 107. The final segment 115 need not be parallel to the axis of back surface 65, as in the previous example, but may deviate at an angle to it and still be tangent to cutting end 106 so as to make a smooth transition.

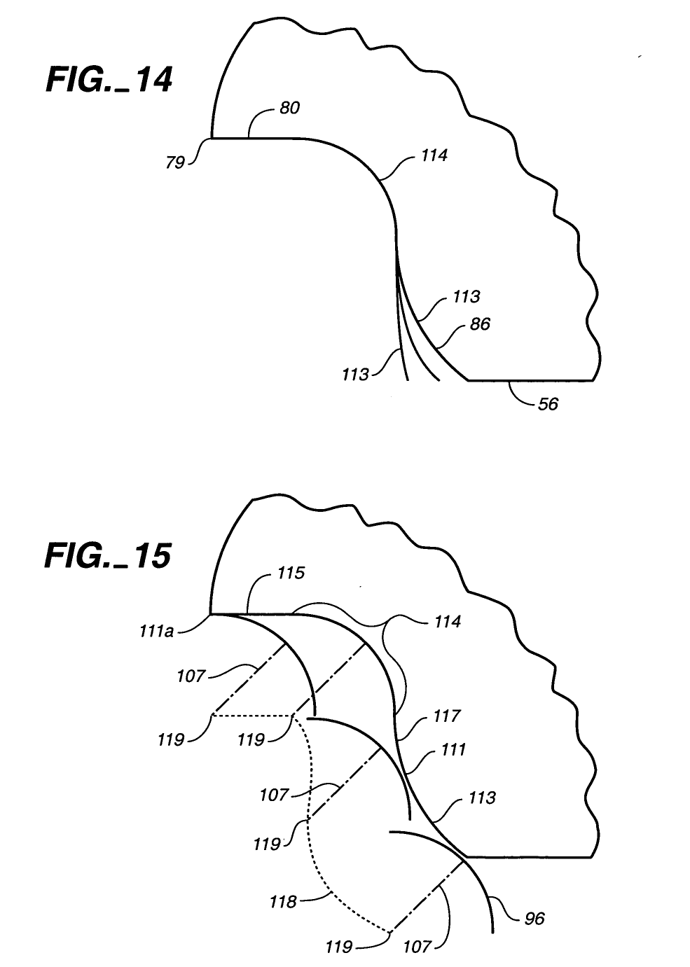

It is not necessary that lenticular segment 113 be formed by moving cutting end 106 along locus of points 86 in a circular path. Cutting end 106 may follow any path chosen by the lens designer, providing that the inward movement for lenticular segment 113 terminates at the start of central segment 114. Hence, lenticular segment 113 may follow a course that ranges from a tilted straight line to various aspheric curves, as shown in FIG. 14. The connection between lenticular segment 113 and central segment 114 need not have a vertical slope but may tilt inwardly or outwardly. If lenticular segment 113 tilts inwardly there will be depthwise motion before a forward motion as cutting tool moves inward.

In order to cut lenticular 53 and secondary prism base 77 a difference is needed between a path 117 of cutting edge 106 and an actual path 118 of cutting tool 69, defined by the motion of the tool center of curvature 119. This difference in motion is known as tool compensation, which requires an exact knowledge of the shape of cutting end 106 and its center of curvature 119. For example, in FIG. 15 the path for center of curvature 119 moves along a transposed path of locus of points 86 to cut lenticular segment 113, stops (instantaneously) for cutting middle segment 114, and moves forward for cutting final segment 115.

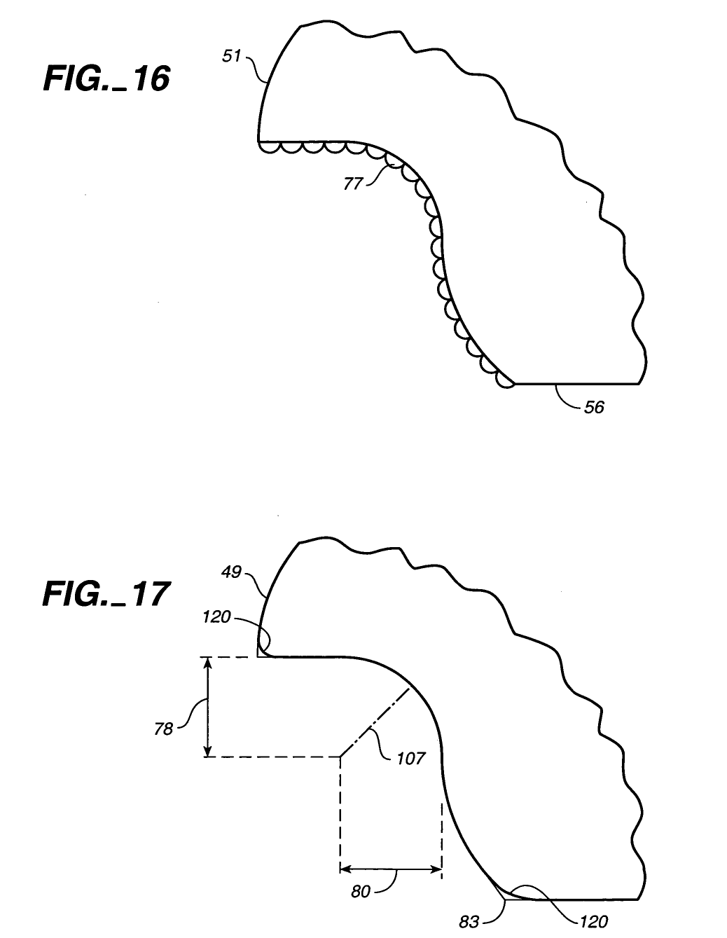

The surface of the base 77 may contain ridges 120, furrows or other irregularities to further enhance friction between the lens and the lid as shown in FIG. 16. The corners 120 formed where base 77 joins with front surface 49 and lenticular 53 joins with lower edge 83 may be rounded as part of the lathe movement or by polishing, as shown in FIG. 17.

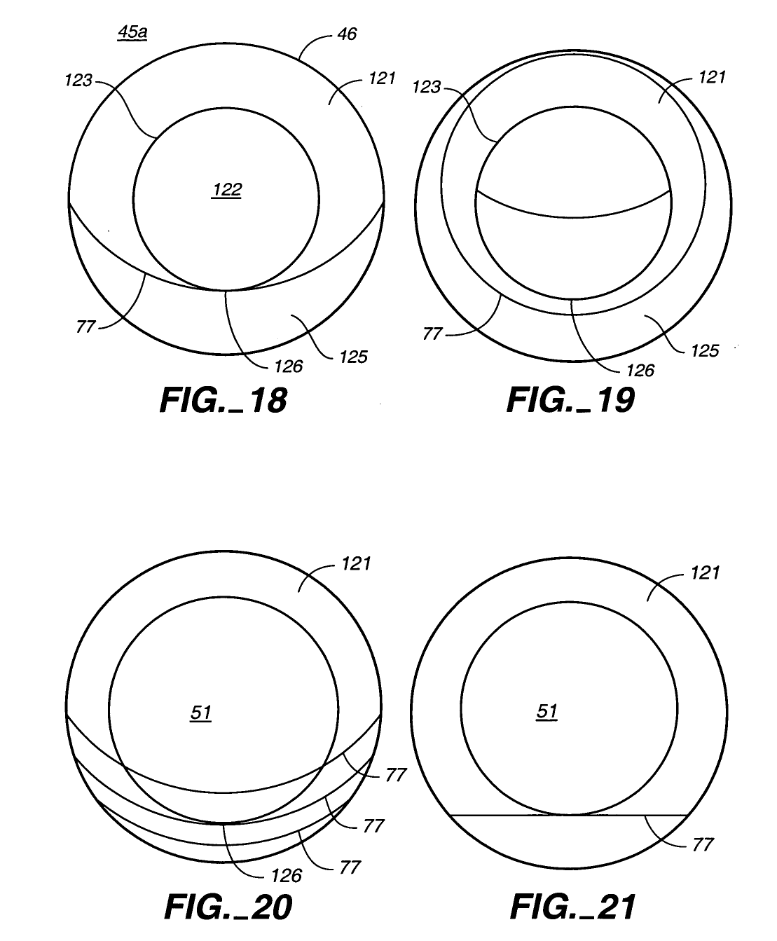

In another embodiment of the present contact lens, a contact lens, 45a has two lenticular curves, which provide a means to control lens thickness in addition to forming secondary prism 52. As shown in FIG. 18, a first lenticular curve 121 surrounds the optical portion, 122 and extends from a junction 123 with optical portion 122 to the perimeter 46 of lens 45a. First lenticular curve 121 may have a longer or shorter radius than optical portion 51 122 as required by the lens thickness. First lenticular curve 121 may have an abrupt change in slope at junction 123 or a fillit may be used to provide a smooth transition. First lenticular curve 121 may be concentric with optical portion 122 or decentered as in FIG. 19, and may have a spherical or an aspherical shape.

Contact lens 45a may be lathed by the method of first cutting front surface 49 comprising optical portion 122 and first lenticular curve 121 in a single pass, together with initial prism 61. Next, base of secondary prism 52 is cut into a portion of first lenticular portion 121, to produce a second lenticular 125, as in FIG. 18. The calculations for the parameters of secondary prism 52 are the same as those presented for contact lens 45 except that lenticular curve 121 is substituted for front surface 49. Secondary prism base 77 may coincide with lowerjunction point 126 or may be above or below lowerjunction 126 as in FIG. 20. If secondary prism base 77 is above lowerjunction 126 a portion of the lower part of optical region 122 will be removed and become at least a part of secondary prism base 77. In addition, secondary prism base 77 does not need to have a circular shape as viewed from the front in isometric projection. Secondary prism base 77 may be a non-circular curve or may appear as a straight line as in FIG. 21, with or without curved ends. The depth of secondary prism base may be constant or it may either increase or decrease as it is extended form secondary prism base 77 towards edge perimeter 46.

### CONCLUSIONS, RAMIFICATION, SCOPE

The optical portion of the lens may contain a single vision or bifocal design. It may also comprise a spherical, toric or aspheric construction. Complex designs will require a computer-controlled lathe.

The fact that the tip of the cutting tool has a finite radius allows the design of a secondary prism base that is compatible with its functional requirements. A base shape is needed that will allow the lower lid to exert force on the base to hold the lens in place but at the same time not be so blunt as to create discomfort. If the need is for a single vision lens that requires minimal movement to create tear exchange or to avoid lens sticking then a narrow base of large radius may suffice. If the need is for a bifocal lens that requires maximum movement for vision, then a wide base of small radius may be required.

In addition to controlling lens movement the secondary prism base may be used to stabilize the lens position during distance vision, both vertically and rotationally. This would have application for lenses designed to correct the aberrations of the eye.

The lens design principles presented would apply either to a lens with zero edge thickness or finite edge thickness by adding a constant to zero edge thickness.

The lens design principles presented can be applied to either hard or soft contact lenses.

As an alternate means of production, the front surface of a contact lens can be formed first and the back surface formed afterwards.

Prism in a contact lens may be produced by offsetting or tilting the lens button. If the back surface is produced by offsetting the center of curvature an appropriate amount then the front surface may be cut with no offset.

The base of a prism is the point or region of greatest thickness and depends on the shape of the prism. As seen from the front in orthogonal projection, if the prism is round the base will appear as a point and if the prism is square the base will appears as one side.

It should be noted that different shapes to secondary prism base may be needed for differences purposes. For bifocal lenses, where maximum contact with the lower lid is required, the base shape may be more abrupt. For single vision lenses, where the goal is to produce some lens movement for tear circulation or to avoid lens sticking, the base shape might have a more gradual slope in order to maximize the lens comfort. A lens can be made a minimum thickness when it is desired to have minimum movement, as in correcting the aberrations of the eye. The minimum thickness can be achieved by using a lenticular design with minimum junction thickness

The lens can be made greater than the minimum thickiness when it is desired to initiate movement for tear exchange beneath the contact lens.

In an alternate method for a concentric bifocal construction, a toric curve or aspheric curve may be placed on the back surface.

The methods described here may be used to form molds that in turn may be used to form contact lenses.

1. A method of making a contact lens from a button of contact lens material, said lens comprising a front surface, a back surface, an optical portion, an edge, a primary prism,_and a secondary prism, comprising:
mounting said button of contact lens material, with said back surface preformed and comprising at least one power, onto an optical lathe having a turning axis,
lathe cutting said front surface based on at least one center of curvature that is offset from said turning axis of said lathe so as to form at least one optical power and an initial prism, and
lathe cutting a portion of said front surface, maintaining said optical portion, and forming said primary and secondary prisms from parts of said initial prism, said secondary prism comprising a base that extends posteriorly and towards said edge from said optical portion, forming a ledge that begins transversely and continues a path toward said edge,
whereby said method allows said contact lens to be made with fewer steps and lower cost than previously.

2. The method of claim 1 wherein said ledge continues in a curved path toward said edge.

3. The method of claim 1 wherein said ledge continues essentially straight for at least part of said path toward said edge.

4. The method of claim 1 wherein said optical portion of said front surface is made in a single vision form selected from the class consisting of spherical, aspherical, and toric curves.

5. The method of claim 1 wherein said optical portion of said front surface is made in a bifocal form.

6. A method of making a contact lens from a button of contact lens material, said lens comprising a front surface, a back surface, a central portion, a lenticular portion, an edge, a primary prism and a secondary prism, comprising:
mounting said button of contact lens material, with said back surface preformed and comprising at least one power, onto an optical lathe having a turning axis,
lathe cutting said front surface based on at least one center of curvature that is offset from said turning axis of said lathe, forming at least one optical power and an initial prism, and
lathe cutting a portion of said front surface to form said lenticular portion, leaving a remaining central portion and forming a secondary prism from part of said initial prism, said secondary prism comprising a base that extends from said_central portion posteriorly and toward said lenticular portion, forming a ledge that begins transversely and continues a path toward said edge,
whereby said method allows said contact lens to be made with fewer steps and lower cost than previously.

7. The method of claim 6 wherein said ledge continues in a curved path toward said edge.

8. The method of claim 6 wherein said ledge continues essentially straight for at least part of said path toward said edge.

9. The method of claim 6 wherein said_central portion of said front surface comprises a single vision form selected from the class consisting of spherical, aspherical, and toric curves.

10. The method of claim 6 wherein said central portion of said front surface comprises a bifocal form.

11. A method of making a contact lens from a button of contact lens material, said lens comprising a front surface, a back surface, an optical portion, an edge, a first lenticular portion, a second lenticular portion, and a secondary prism, comprising:
mounting said button of contact lens material, with said back surface preformed and comprising at least one power onto an optical lathe having a turning axis,
lathe cutting said front surface based on at least one center of curvature that is offset from said turning axis of said lathe, forming an optical portion, a first lenticular portion, and an initial prism and,
lathe cutting a portion of said front surface to form a second lenticular portion, leaving a remaining optical portion and forming a secondary prism from part of said initial prism, said secondary prism comprising a base that extends from a lower region of said contact lens posteriorly and toward said second lenticular portion, forming a ledge that begins transversely and continues a path toward said edge
whereby said method allows said contact lens to be made with fewer steps and lower cost than previously.

12. The method of claim 11 wherein said ledge continues in a curved path toward said edge.

13. The method of claim 11 wherein said ledge continues essentially straight for at least part of said path toward said edge.

14. The method of claim 11 wherein said optical portion of said front surface is made in a single vision form selected from the class consisting of spherical, aspherical, and toric curves.

15. The method of claim 11 wherein said optical portion of said front surface is made in a bifocal form.

16. The method of claim 11 wherein said first lenticular portion is comprised of a spherical curve.

17. The method of claim 11 wherein said first lenticular portion is comprised of at least two radii.

18. The method of claim 11 wherein said first lenticular portion is comprised of an aspherical curve.

19. The method of claim 11 wherein said optical portion and said first lenticular portion form a junction at which there is a change in slope.

20. The method of claim 11 wherein said optical portion and said first lenticular portion form a junction that is smooth.
